(19) United States
(12) Patent Application Publication
(10) Pub. No.: US 2009/0281341 A1
(43) Pub. Date: Nov. 12, 2009

(54) METAL-ORGANIC ZIRCONIUM-BASED FRAMEWORK MATERIALS

(75) Inventors: Markus Schubert, Ludwigshafen (DE); Ulrich Müller, Neustadt (DE); Stefan Marx, Berlin (DE)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/297,294

(22) PCT Filed: Apr. 17, 2007
(86) PCT No.: PCT/EP2007/053704

§ 371 Date: Dec. 18, 2008

(30) Foreign Application Priority Data
Apr. 18, 2006 (EP) 06112714.8

(51) Int. Cl. C07F 7/00

(52) U.S. Cl. 556/51

(57) ABSTRACT

The present invention relates to a porous metal-organic framework material comprising at least one at least bidentate organic compound which is bound to at least one metal ion by coordination, the at least one metal ion being zirconium, and the at least one at least bidentate organic compound being derived from a dicarboxylic, tricarboxylic or tetracarboxylic acid. In addition, the invention relates to methods for production thereof and also use thereof.

The present invention relates to porous metal-organic framework materials, methods for production thereof and also use thereof.

Porous metal-organic framework materials are known in the prior art and form an interesting class of substances which, for various applications, are an alternative to inorganic zeolites.

Metal-organic framework materials customarily comprise an at least bidentate organic compound bound to a metal ion by coordination. Typically, the framework material is present as an endless framework. A special group of these metal-organic framework materials is described recently as what is termed “limited” framework materials in which the framework, by a special choice of the organic compound, does not extend endlessly, but with the formation of polyhedra (A. C. Sudik et al., J. Am. Chem. Soc. 127 (2005), 7110-7118). However, the last-mentioned special group is ultimately also a porous metal-organic framework material.

Known applications for which the metal-organic framework materials have been used are, for example, in the field of storage, separation or controlled release of chemical substances, such as, for example, gases, or in the field of catalysis. In this case, in addition to the porosity of the organic material, choice of the corresponding metal ion plays an important role.

In the literature, special porous metal-organic framework materials based on zirconium are proposed for certain fields.

For instance, H. L. Ngo et al., J. Mol. Catal. A. Chemical 215 (2004), 177-186, for example, describe zirconium metal-organic framework materials, a bisnapthyl diphosphonate being used as bidentate organic compound, the hydroxylate groups in addition being able to be bound to Ti, without the titanium participating in the framework structure.

A. Hu et al., J. Am. Chem. Soc. 125 (2003), 11490-11491, likewise describes such zirconium-based metal-organic framework materials for the heterogeneous asymmetrical hydrogenation of aromatic ketones, however, instead of titanium, ruthenium being used, and the hydroxyl groups being replaced by phosphine.

All of the abovementioned publications have in common the fact that they describe very special metal-organic framework materials based on zirconium, organic compounds which are relatively expensive and difficult to make being used, which also can only be produced in small amounts for laboratory purposes.

There is therefore a requirement for porous metal-organic framework materials which are based on zirconium, can be produced in a relatively simple manner and are robust. In addition, such framework materials must be able to be produced in amounts which go beyond the laboratory scale.

One object of the present invention is thus to provide such framework materials and also production methods for them so that the abovementioned advantages occur at least in part and the resultant metal-organic framework materials are accessible at least in comparable manner for applications which are typical of metal-organic framework materials or go beyond them.

The object is achieved by a porous metal-organic framework material comprising at least one at least bidentate organic compound which is bound to at least one metal ion by coordination, the at least one metal ion being zirconium, and the at least one at least bidentate organic compound being derived from a dicarboxylic, tricarboxylic or tetracarboxylic acid.

This is because it has been found that, owing to the selection of the metal, and also the at least bidentate organic compound, framework materials can be obtained which firstly can be synthesized readily in large amounts and can be fed to the most varied applications.

The inventive porous metal-organic framework material comprises at least one metal ion. This metal ion is an ion of zirconium.

However, it is likewise possible that more than one metal ion is present in the porous metal-organic framework material. This metal ion can be situated in the pores in the metal-organic framework material, or can participate in the structure of the framework grid. In the last-mentioned case, the at least one at least bidentate organic compound would bind to such a metal ion, or a further at least bidentate organic compound would bind to it.

In this case, in principle any metal ion can come into consideration which is appropriately suitable for being part of the porous metal-organic framework material.

If more than one metal ion is present in the porous metal-organic framework material, they can be present in stochiometric, or nonstochiometric, amounts. If coordination places are exchanged by a further metal ion and this is in a non-stochiometric ratio to the zirconium metal ion, such a porous metal-organic framework material can be considered to be a doped framework material. Production of such doped metal-organic framework materials in general is described in German patent application No. 10 2005 053 430.9.

In addition, the porous metal-organic framework material can be impregnated by a further metal in the form of a metal salt. A method for impregnation is described, for example, in EP-A 1070538.

If a further metal ion is present in the stochiometric ratio to zirconium, mixed metallic framework materials are present. In this case, the further metal ion may or may not participate in the framework structure.

Preferably, the framework is made up only of zirconium metal ions and the at least one at least bidentate organic compound.

The framework material can be in polymer or polyhedral form.

In the context of the present invention, zirconium is preferably present in oxidation state +4.

In addition the porous metal-organic framework material comprises at least one at least bidentate organic compound, this being derived from a dicarboxylic, tricarboxylic or tetracarboxylic acid. Further at least bidentate organic compounds can participate in the structure of the framework material. However, it is also possible that, in addition, organic compounds which are not at least bidentate are also present in the framework material. These can be derived, for example, from a monocarboxylic acid.

The term “derive”, in the context of the present invention, means that the dicarboxylic, tricarboxylic or tetracarboxylic acid can be present in the framework material in partially deprotonated, or completely deprotonated, form. In addition, the dicarboxylic, tricarboxylic or tetracarboxylic acid can comprise a substituent, or independently of one another, a plurality of substituents. Examples of such substituents are —OH, —NH₂, —OCH₃, —CH₃, —NH(CH₃), —N(CH₃)₂, —CN and also halides. In addition, the term “derive” in the context of the present invention means that the dicarboxylic, tricarboxylic or tetracarboxylic acid can also be present in the form of the corresponding sulfur analogues. Sulfur analogues are the functional groups —C(═O)SH and also tautomers thereof and C(═S)SH, which can be used instead of one or more carboxylic acid groups. In addition, the term “derive” in the context of the present invention means that one or more carboxylic acid functions can be replaced by a sulfone(—SO₃)H. In addition, in addition to the 2, 3 or 4 carboxylic acid functions, a sulfonic acid group can be present.

The dicarboxylic, tricarboxylic or tetracarboxylic acid, in addition to the abovementioned functional groups, can have an organic parent body or an organic compound to which they are bound. In this case the abovementioned functional groups can in principle be bound to any suitable organic compound, provided that it is ensured that the organic compound having these functional groups is capable of developing the coordinate bond to produce the framework material.

Preferably, the organic compounds are derived from a saturated or unsaturated aliphatic compound, or an aromatic compound, or a compound which is both aliphatic and aromatic.

The aliphatic compound, or the aliphatic part of the compound which is both aliphatic and aromatic, can be linear and/or branched and/or cyclic, a plurality of cycles per compound also being possible. Further preferably, the aliphatic compound, or the aliphatic part of the compound which is both aliphatic and aromatic comprises 1 to 18, further preferably 1 to 14, further preferably 1 to 13, further preferably 1 to 12, further preferably 1 to 11, and in particular preferably 1 to 10, carbon atoms such as, for example, 1, 2, 3, 4, 5, 6, 7, 8, 9, or 10 carbon atoms. In particular preference is given in this case, inter alia, to methane, adamantane, acetylene, ethylene or butadiene.

The aromatic compound or the aromatic part of the compound which is both aromatic and aliphatic can have one or more nuclei such as, for example, two, three, four or five nuclei, the nuclei being able to be present separately from one another and/or at least two nuclei in condensed form. Particularly preferably, the aromatic compound, or the aromatic part of the compound which is both aliphatic and aromatic, has one, two or three nuclei, one or two nuclei being particularly preferred. Independently of one another, in addition each nucleus of said compound can comprise at least one heteroatom such as, for example, N, O, S, B, P, Si, preferably N, O and/or S. Further preferably, the aromatic compound, or the aromatic part of the compound which is both aromatic and aliphatic, comprises one or two C₆ nuclei, the two either being present separately from one another or in condensed form. In particular, as aromatic compounds, mention may be made of benzene, naphthalene and/or biphenyl and/or bipyridyl and/or pyridyl.

More preferably, the at least bidentate organic compound is an aliphatic or aromatic, acyclic or cyclic hydrocarbon having 1 to 18, preferably 1 to 10, and in particular 6, carbon atoms, which, in addition, solely has 2, 3 or 4 carboxyl groups as functional groups.

For example, the at least bidentate organic compound is derived from a dicarboxylic acid, such as, for instance, oxalic acid, succinic acid, tartaric acid, 1,4-butanedicarboxylic acid, 1,4-butenedicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzene-dicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzene-dicarboxylic acid, p-benzenedicarboxylic acid, imidazole-2,4-dicarboxylic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylim idazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxaoctanedicarboxylic acid, 3,5-cyclo-hexadiene-1,2-dicarboxylic acid, octanedicarboxylic acid, pentane-3,3-dicarboxylic acid, 4,4′-diamino-1,1′-diphenyl-3,3′-dicarboxylic acid, 4,4′-diaminodiphenyl-3,3′-dicarboxylic acid, benzidine-3,3′-dicarboxylic acid, 1,4-bis(phenylamino)benzene-2,5-dicarboxylic acid, 1,1′-binaphthyidicarboxylic acid, 7-chloro-8-methylquinoline-2,3-dicarboxylic acid, 1 -anilinoanthraquinone-2,4′-dicarboxylic acid, poly-tetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxy)phenyl-3-(4-chloro)phenylpyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazine-dicarboxylic acid, 4,4′-diamino(diphenyl ether)diimidedicarboxylic acid, 4,4′-diaminodiphenylmethanediimidedicarboxylic acid, 4,4′-diamino(diphenyl sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenedicarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptane-dicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxy-diphenylmethane-3,3′-dicarboxylic acid, 1-amino-4-methyl-9,10-dioxo-9,10-dihydroanthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitro-benzene-1,4-dicarboxylic acid, heptane-1,7-dicarboxylic acid, cyclobutane-1,1-dicarboxylic acid, 1,14-tetradecanedicarboxylic acid, 5,6-dehydronorbomane-2,3-dicarboxylic acid, 5-ethyl-2,3-pyridinedicarboxylic acid or camphordicarboxylic acid.

In addition, more preferably, the at least bidentate organic compound is a dicarboxylic acid mentioned by way of example above as such.

For example, the at least bidentate organic compound can be derived from a tricarboxylic acid, such as for instance

2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methyl-benzene-1,2,4-tricarboxylic acid, 3-amino-5-benzoyl-6-methylbenzene-1 ,2,4-tricarboxylic acid, 1,2,3-propanetricarboxylic acid or aurintricarboxylic acid.

In addition, more preferably, the at least bidentate organic compound is one of the tricarboxylic acids mentioned above by way of example as such.

For example, an at least bidentate organic compound which is derived from a tetracarboxylic acid, such as, for instance,

1,1-dioxidoperylo[1,12-BCD]thiophene-3,4,9,10-tetracarboxylic acid, perylene-tetracarboxylic acids such as perylene-3,4,9,10-tetracarboxylic acid or perylene-1,12-sulfone-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octane-tetracarboxylic acid, 1,4,5,8-naphthalenetetracarboxylic acid, 1,2,9,10-decanetetracarboxylic acid, benzophenonetetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

In addition, more preferably, the at least bidentate organic compound is one of the tetracarboxylic acids mentioned by way of example above as such.

Very particular preference is given to using optionally at least monosubstituted aromatic dicarboxylic, tricarboxylic or tetracarboxylic acids having one, two, three, four or more rings, with each of the rings being able to comprise at least one heteroatom and two or more rings being able to comprise identical or different heteroatoms Examples of preferred carboxylic acids of this type are one-ring dicarboxylic acids, one-ring tricarboxylic acids, one-ring tetracarboxylic acids, two-ring dicarboxylic acids, two-ring tricarboxylic acids, two-ring tetracarboxylic acids, three-ring dicarboxylic acids, three-ring tricarboxylic acids, three-ring tetracarboxylic acids, four-ring dicarboxylic acids, four-ring tricarboxylic acids and/or four-ring tetracarboxylic acids. Suitable heteroatoms are, for example, N, O, S, B, P, and preferred heteroatoms are N, S and/or O. Suitable substituents are, inter alia, —OH, a nitro group, an amino group or an alkyl or alkoxy group.

In particular preferably, as at least bidentate organic compounds, use is made of acetylenedicarboxylic acid (ADC), camphordicarboxylic acid, fumaric acid, succinic acid, benzenedicarboxylic acids, naphthalenedicarboxylic acids, biphenyldicarboxylic acids such as 4,4′-biphenyldicarboxylic acid (BPDC), pyrazinedicarboxylic acids, such as 2,5-pyrazinedicarboxylic acid, bipyridinedicarboxylic acids such as 2,2′-bipyridinedicarboxylic acids, e.g. 2,2′-bipyridine-5,5′-dicarboxylic acid, benzenetricarboxylic acids such as 1,2,3-, 1,2,4-benzenetricarboxylic acid or 1,3,5-benzenetricarboxylic acid (BTC), benzenetetracarboxylic acid, adamantanetetracarboxylic acid (ATC), adamantanedibenzoate (ADB), benzenetribenzoate (BTB), methanetetrabenzoate (MTB), adamantanetetrabenzoate or dihydroxyterephthalic acids such as 2,5-dihydroxyterephthalic acid (DHBDC).

Very particular preference is given, inter alia, to phthalic acid, isophthalic acid, terephthalic acid, 2,6-napthalenedicarboxylic acid, 1,4-naphthalenedicarboxylic acid, 1,5-napthalenedicarboxylic acid, 1,2,3-benzenetricarboxylic acid, 1,2,4-berizenetricarboxylic acid, 1,3,5-benzenetricarboxylic acid, or 1,2,4,5-benzenetetracarboxylic acid.

In addition to these at least bidentate organic compounds, the metal-organic framework material can also comprise one or more monodentate ligands and/or one or more at least bidentate ligands which are not derived from a dicarboxylic, tricarboxylic or tetracarboxylic acid.

Preferably, the at least one at least bidentate organic compound does not comprise hydroxyl or phosphonic acid groups.

As has already been discussed, one or more carboxylic acid functions can be replaced by a sulfonic acid function. In addition, a sulfonic acid group can additionally be present. Finally, it is likewise possible that all carboxylic acid functions are replaced by a sulfonic acid function.

Such sulfonic acids and salts thereof which are commercially available are, for example, 4-amino-5-hydroxynaphthalene-2,7-disulfonic acid, 1-amino-8-naphthol-3,6-disulfonic acid, 2-hydroxynaphthalene-3,6-disulfonic acid, benzene-1,3-disulfonic acid, 1,8-dihydroxynaphthalene-3,6-disulfonic acid, 1,2-dihydroxy-benzene-3,5-disulfonic acid, 4,5-dihydroxynaphthalene-2,7-disulfonic acid, 2,9-dimethyl-4,7-diphenyl-1,10-phenanthrolene disulfonic acid, 4,7-diphenyl-1,10-phenanthrolene disulfonic acid, ethane-1,2-disulfonic acid, naphthalene-1,5-disulfonic acid, 2-(4-nitrophenylazo)-1,8,-dihydroxynapthalene-3,6-disulfonic acid, 2,2′-dihydroxy-1,1′-azonaphthalene-3′,4,6′-trisulfonic acid.

The inventive metal-organic framework materials comprise pores, in particular micro- and/or mesopores. Micropores are defined as those having a diameter of 2 nm or less and mesopores are defined by a diameter in the range from 2 to 50 nm, in each case in accordance with the definition as given in Pure Applied 5, Chem. 57 (1985), pages 603-619, in particular on page 606. The presence of micro- and/or mesopores can be investigated using sorption measurements, these measurements determining the uptake capacity of metal-organic framework materials for nitrogen at 77 kelvin as specified in DIN 66131 and/or DIN 66134.

Preferably, the specific surface area, calculated by the Langmuir model (DIN 66131, 66134) of an MOF in powder form is greater than 5 m²/g, more preferably, greater than 10 m²/g, more preferably greater than 50 m²/g, further more preferably greater than 500 m²/g, further more preferably greater than 1000 m²/g.

Shaped bodies made of metal-organic framework materials can have a lower specific surface area; preferably, however, greater than 10 m²/g, more preferably greater than 50 m²/g, further more preferably greater than 500 m²/g.

The pore size of the porous metal-organic framework material can be controlled by selection of the suitable ligand and/or the at least bidentate organic compound. In general it is true that the greater the organic compound, the greater is the pore size. Preferably, the pore size is from 0.2 nm to 30 nm, particularly preferably the pore size is in the range from 0.3 nm to 3 nm, based on the crystalline material.

In a shaped body of the metal-organic framework material, however, larger pores occur, the pore size distribution of which can vary. Preferably, however, more than 50% of the total pore volume, in particular more than 75%, of pores are formed having a pore diameter of up to 1000 nm. Preferably, however, a majority of the pore volume is formed by pores from two diameter ranges. It is therefore further preferred when more than 25% of the total pore volume, in particular more than 50% of the total pore volume, is formed by pores which are in a diameter range from 100 nm to 800 nm, and when more than 15% of the total pore volume, in particular more than 25% of the total pore volume, is formed by pores which are in a diameter range of up to 10 nm. The pore size distribution can be determined by means of mercury porosimetry.

The metal-organic framework material can be present in pulverulent form or as agglomerate. The framework material can be used as such or it is converted into a shaped body. Accordingly, a further aspect of the present invention is a shaped body comprising the inventive metal-organic framework material.

The production of shaped bodies from metal-organic framework materials is described, for example, in WO-A 03/102000.

Preferred methods for producing shaped bodies in this case are extrusion or tableting. In the production of shaped bodies, the framework material can have further materials, such as, for example, binders, lubricants or other additives which are added during production. It is likewise conceivable that the framework material has further components, such as, for example, absorbents, such as activated carbon or the like.

With respect to possible geometries of the shaped bodies, essentially no restrictions exist. For example, examples of pellets which may be mentioned are, for example, disk-shaped pellets, pills, spheres, granules, extrudates such as, for example, rods, honeycombs, grids and hollow bodies.

For production of these shaped bodies, in principle all suitable methods are possible. In particular, the following procedures are preferred:

Kneading/milling the framework material alone or together with at least one binder and/or at least one pasting agent and/or at least one template compound to produce a mixture; shaping the resultant mixture by means of at least one suitable method such as, for example, extrusion; optionally washing and/or drying and/or calcining the extrudate; optionally finishing.

Tableting together with at least one binder and/or aid.

Applying the framework material to at least one if appropriate porous support material. The resultant material can then be further processed in accordance with the above described method to give a shaped body.

Applying the framework material to at least one if appropriate porous substrate.

Kneading/milling and shaping can proceed according to any suitable method such as described, for example, in Ullmanns Enzyklopädie der Technischen Chemie [Ullmann's Encyclopedia of Industrial Chemistry], 4th Edition, Volume 2, pages 313 ff. (1972).

For example, the kneading/milling and/or shaping can proceed by means of a piston press, roller press in the presence of absence of at least one binder, compounding, pelleting, tableting, extrusion, co-extrusion, foaming, spinning, coating, granulation, preferably spray-granulation, spraying, spray-drying, or a combination of two or more of these methods.

Very particularly preferably, pellets and/or tablets are produced.

The kneading and/or shaping can proceed at elevated temperatures such as, for example, in the range from room temperature to 300° C., and/or at elevated pressure, such as, for example, in the range from atmospheric pressure up to a few hundred bar and/or in a protective gas atmosphere such as, for example, in the presence of at least one noble gas, nitrogen, or a mixture of two or more thereof.

The kneading and/or shaping is carried out according to a further embodiment with addition of at least one binder, as binder, use being able to be made in principle of any chemical compound which ensures the viscosity desired for kneading and/or shaping of the mix to be kneaded and/or shaped. Accordingly, binders, in the meaning of the present invention, can be not only viscosity-increasing, but also viscosity-decreasing compounds.

Preferred binders include, for example, aluminum oxide or binders comprising aluminum oxide as described, for example, in WO 94/29408, silicon dioxide as described, for example, in EP 0 592 050 A1, mixtures of silicon dioxide and aluminum oxide as described, for example, in WO 94/13584, clay minerals as described, for example, in JP 03-037156 A, for example montmorillonite, kaolin, bentonite, hallosite, dickite, nacrite and anauxite, alkoxysilanes as described, for example, in EP 0 102 544 B1, for example tetraalkoxysilanes such as tetramethoxysilane, tetraethoxysilane, tetrapropoxysilane, tetrabutoxysilane, and, for example, trialkoxysilanes such as trimethoxysilane, triethoxysilane, tripropoxysilane, tributoxysilane, alkoxytitanates, for example tetraalkoxytitanates such as tetramethoxytitanate, tetraethoxytitanate, tetrapropoxytitanate, tetrabutoxytitanate, and, for example, trialkoxytitanates such as trimethoxytitanate, triethoxytitanate, tripropoxytitanate, tributoxytitanate, alkoxyzirconates, for example tetraalkoxyzirconates such as tetramethoxyzirconate, tetraethoxyzirconate, tetrapropoxyzirconate, tetrabutoxyzirconate, and, for example, trialkoxyzirconates such as trimethoxyzirconate, triethoxyzirconate, tripropoxyzirconate, tributoxyzirconate, silica sols, amphiphilic substances and/or graphites.

As viscosity-increasing compound, it is also possible, for example, to use, if appropriate in addition to the abovementioned compounds, an organic compound and/or a hydrophilic polymer such as cellulose or a cellulose derivative such as methylcellulose and/or a polyacrylate and/or a polymethacrylate and/or a polyvinyl alcohol and/or a polyvinylpyrrolidone and/or a polyisobutene and/or a polytetrahydrofuran and/or a polyethylene oxide.

As pasting agent, preference is given to using, inter alia, water or at least one alcohol, for example a monoalcohol having from 1 to 4 carbon atoms, e.g. methanol, ethanol, n-propanol, isopropanol, 1-butanol, 2-butanol, 2-methyl-1-propanol or 2-methyl-2-propanol, or a mixture of water and at least one of the alcohols mentioned or a polyhydric alcohol such as a glycol, preferably a water-miscible polyhydric alcohol, either alone or as a mixture with water and/or at least one of the monohydric alcohols mentioned.

Further additives which can be used for kneading and/or shaping are, inter alia, amines or amine derivatives such as tetraalkylammonium compounds or amino alcohols and carbonate-comprising compounds such as calcium carbonate. Such further additives are described, for instance, in EP 0 389 041 A1, EP 0 200 260 A1 or WO 95/19222.

The order of addition of the additives such as template compound, binder, pasting agent, viscosity-increasing substance in shaping and kneading is in principle not critical.

In a further preferred embodiment, the shaped body obtained by kneading and/or shaping is subjected to at least one drying operation which is generally carried out at a temperature in the range from 25 to 500° C., preferably in the range from 50 to 500° C. and particularly preferably in the range from 100 to 350° C. It is likewise possible to carry out drying under reduced pressure or under a protective gas atmosphere or by spray drying.

In a particularly preferred embodiment, at least one of the compounds added as additives is at least partly removed from the shaped body during this drying operation.

The present invention further relates to a method for producing an inventive porous metal-organic framework material, the step comprising

reaction of at least one zirconium compound with at least one at least bidentate organic compound which can bind to the metal by coordination.

The zirconium compound is preferably an alkoxide, acetonate, halide, sulfide, salt of an organic or inorganic oxygen-comprising acid, or a mixture thereof.

An alkoxide is, for example, a methoxide, ethoxide, n-propoxide, isopropoxide, n-butoxide, isobutoxide, t-butoxide, or phenoxide.

An acetonate is, for example, acetylacetonate.

A halide is, for example, chloride, bromide or iodide.

An organic oxygen-comprising acid is, for example, formic acid, acetic acid, propionic acid, or other alkylmonocarboxylic acids.

An inorganic oxygen-comprising acid is, for example, sulfuric acid, sulfurous acid, phosphoric acid or nitric acid.

In this case the zirconium preferably occurs as Zr⁴⁺ or Zro²⁺ cation.

Further preferred zirconium compounds are zirconium tetraisobutoxide, zirconium tetra-n-butoxide, zirconium acetate, zirconium chloride, zirconium oxychloride, zirconium sulfate, zirconium phosphate, zirconium oxynitrate, zirconium hydrogen-sulfate.

Further more preferably, the zirconium compound is an inorganic zirconium salt.

The reaction in the inventive method preferably proceeds in the presence of a nonaqueous solvent.

The reaction preferably proceeds at a pressure of at most 2 bar (absolute). Preferably, however, the pressure is at most 1230 mbar (absolute). In particular preferably, the reaction takes place at atmospheric pressure. In this case, however, slight over pressures or under pressures may occur due to the apparatus. Therefore, in the context of the present invention, the term “atmospheric pressure” is to be taken to mean that pressure range which results from the actual atmospheric pressure occurring ±150 mbar.

The reaction can be carried out at room temperature. Preferably, however, it takes place at temperatures above room temperature. Preferably, the temperature is above 100° C. Further preferably, the temperature is at most 180° C., and more preferably at most 150° C.

Typically, the above described metal-organic framework materials are carried out in water as solvent with addition of a further base. This serves, in particular, for, when a polybasic carboxylic acid is used as at least bidentate organic compound, it is readily soluble in water. As a result of the preferred use of the nonaqueous organic solvent, it is not necessary to use such a base. Nevertheless, the solvent for the inventive method can be selected in such a manner that it has a basic reaction as such, which however need not be obligatory for carrying out the inventive method.

Likewise, use can be made of a base. However, it is preferred that no additional base is used.

It is further advantageous that the reaction can take place with stirring, which is also advantageous in the case of scaleup.

The nonaqueous organic solvent is preferably a C₁₋₆-alkanol, dimethyl sulfoxide (DMSO), N,N-dimethylformamide (DMF), N,N-diethylformamide (DEF), acetonitrile, toluene, dioxane, benzene, chlorobenzene, methyl ethyl ketone (MEK), pyridine, tetrahydrofuran (THF), ethyl acetate, optionally halogenated C₁₋₂₀₀-alkane, sulfolane, glycol, N-methylpyrrolidone (NMP), gamma-butyrolactone, alicyclic alcohols, such as cyclohexanol, ketones, such as acetone or acetylacetone, cycloketones, such as cyclohexanone, sulfolene, or mixtures thereof.

A C₁₋₆-alkanol designates an alcohol having 1 to 6 carbon atoms. Examples of this are methanol, ethanol, n-propanol, isopropanol, n-butanol, isobutanol, t-butanol, pentanol, hexanol, and also mixtures thereof.

An optionally halogenated C₁₋₂₀₀-alkane designates an alkane having 1 to 200 carbon atoms, one or more up to all hydrogen atoms being able to be replaced by halogen, preferably chloride or fluorine, in particular chlorine. Examples thereof are chloroform, dichloromethane, tetrachloromethane, dichloroethane, hexane, heptane, octane and also mixtures thereof.

Preferred solvents are DMF, DEF and NMP. Particular preference is given to DMF.

The term “nonaqueous” preferably relates to a solvent which does not exceed a maximum water content of 10% by weight, more preferably 5% by weight, further more preferably 1% by weight, further preferably 0.1% by weight, particularly preferably 0.01% by weight, based on the total weight of the solvent.

Preferably, the maximum water content during the reaction is 10% by weight, more preferably 5% by weight, and further more preferably 1% by weight.

The term “solvent” relates to pure solvents and also mixtures of different solvents.

Further preferably, the method step of the reaction of the at least one metal compound with the at least one at least bidentate organic compound is followed by a calcination step. The temperature set in this case is typically above 250° C., preferably 300 to 400° C.

On account of the calcination step, the at least bidentate organic compound situated in the pores can be removed.

In supplementation thereto, or alternatively thereto, the at least bidentate organic compound (ligand) can be removed from the pores of the porous metal-organic framework material by treating the framework material formed with a nonaqueous solvent. In this case, the ligand is removed in a type of “extraction method” and if appropriate replaced in the framework material by a solvent molecule. This gentle method is suitable in particular when the ligand is a high-boiling compound.

The treatment is preferably performed for at least 30 minutes, and can typically be carried out for up to 2 days. This can take place at room temperature or elevated temperature. Preferably it proceeds under elevated temperature, for example at at least 40° C., preferably 60° C. Further preferably, the extraction proceeds at the boiling temperature of the solvent used (under reflux).

The treatment can proceed in a simple vessel by slurrying and stirring the framework material. Use can also be made of extraction apparatuses such as Soxhlet apparatuses, in particular industrial extraction apparatuses.

Suitable solvents which can be used are the abovementioned, that is, for example, C₁₋₆-alkanol, dimethyl sulfoxide (DMSO), N,N-dimethylformamide (DMF), N,N-diethylformamide (DEF), acetonitrile, toluene, dioxane, benzene, chlorobenzene, methyl ethyl ketone (MEK), pyridine, tetrahydrofuran (THF), ethyl acetate, optionally halogenated C₁₋₂₀₀-alkane, sulfolane, glycol, N-methyl-pyrrolidone (NMP), gamma-butyrolactone, alicyclic alcohols, such as cyclohexanol, ketones, such as acetone or acetylactone, cycloketones, such as cyclohexanone, or mixtures thereof.

Preference is given to methanol, ethanol, propanol, acetone, MEK, and mixtures thereof.

A very particularly preferred extraction solvent is methanol.

The solvent used for the extraction can be identical or different to that for the reaction of the at least one metal compound with the at least one at least bidentate organic compound. In particular, in “extraction” it is not absolutely required, but preferred, that the solvent is anhydrous.

The present invention further relates to the use of an inventive porous metal-organic framework material for the uptake of at least one substance for its storage, separation, controlled release or chemical reaction, and also as support or precursor material for the production of a corresponding metal oxide.

If the inventive porous metal-organic framework material is used for storage, this preferably proceeds in a temperature range from −200° C. to +80° C. More preference is given to a temperature range of from −40° C. to +80° C.

The at least one substance can be a gas or a liquid. Preferably, the substance is a gas.

In the context of the present invention, the terms “gas” and “liquid” are used in the interests of simplicity, but gas mixtures and liquid mixtures or liquid solutions are likewise encompassed by the term “gas” or “liquid”.

Preferred gases are hydrogen, natural gas, town gas, saturated hydrocarbons, in particular methane, ethane, propane, n-butane and also isobutene, unsaturated hydrocarbons, in particular ethene and propene, carbon monoxide, carbon dioxide, nitrogen oxides, oxygen, sulfur oxides, halogens, halogenated hydrocarbons, NF₃, SF₆, ammonia, boranes, phosphanes, hydrogen sulfide, amines, formaldehyde, noble gasses, in particular helium, neon, argon, krypton and also xenon.

However, the at least one substance can also be a liquid. Examples of such liquids are disinfectants, inorganic or organic solvents, fuels, in particular gasoline or diesel, hydraulic fluids, radiator fluids, brake fluids or an oil, in particular machine oil. Furthermore, the liquid can also be a halogenated aliphatic or aromatic, cyclic or acyclic hydrocarbon or a mixture thereof. In particular, the liquid can be acetone, acetonitrile, aniline, anisole, benzene, benzonitrile, bromobenzene, butanol, tert-butanol, quinoline, chlorobenzene, chloroform, cyclohexane, diethylene glycol, diethyl ether, dimethylacetamide, dimethylformamide, dimethyl sulfoxide, dioxane, glacial acetic acid, acetic anhydride, ethyl acetate, ethanol, ethylene carbonate, ethylene dichloride, ethylene glycol, ethylene glycol dimethyl ether, formamide, hexane, isopropanol, methanol, methoxypropanol, 3-methyl-1-butanol, methylene chloride, methyl ethyl ketone, N-methylformamide, N-methylpyrrolidone, nitrobenzene, nitromethane, piperidine, propanol, propylene carbonate, pyridine, carbon disulfide, sulfolane, tetrachloroethene, carbon tetrachloride, tetrahydrofuran, toluene, 1,1,1-trichloroethane, trichloroethylene, triethylamine, triethylene glycol, triglyme, water or a mixture thereof.

In addition, the at least one substance can be an odorant.

The odorant is preferably a volatile organic or inorganic compound which comprises at least one of the elements nitrogen, phosphorous, oxygen, sulfur, fluorine, chlorine, bromine or iodine or is an unsaturated or aromatic hydrocarbon or a saturated or unsaturated aldehyde or a ketone. More preferred elements are nitrogen, oxygen, phosphorous, sulfur, chlorine, bromine; and particular preference is given to nitrogen, oxygen, phosphorous and sulfur.

In particular, the odorant is ammonia, hydrogen sulfide, sulfur oxides, nitrogen oxides, ozone, cyclic or acyclic amines, thiols, thioethers and also aldehydes, ketones, esters, ethers, acids or alcohols. Particular preference is given to ammonia, hydrogen sulfide, organic acids (preferably acetic acid, propionic acid, butyric acid, isobutyric acid, valeric acid, isovaleric acid, caproic acid, heptanoic acid, lauric acid, pelargonic acid) and cyclic or acyclic hydrocarbons which comprise nitrogen or sulfur and also saturated or unsaturated aldehydes such as hexanal, heptanal, octanal, nonanal, decanal, octenal or nonenal and in particular volatile aldehydes such as butyraldehyde, propionaldehyde, acetaidehyde and formaldehyde and also fuels such as gasoline, diesel (components).

The odorants can also be fragrances which are used, for example, for producing perfumes. Fragrances or oils which release such fragrances which may be mentioned by way of example are: essential oils, basil oil, geranium oil, mint oil, cananga oil, cardamom oil, lavender oil, peppermint oil, nutmeg oil, camomile oil, eucalyptus oil, rosemary oil, lemon oil, lime oil, orange oil, bergamot oil, muscatel sage oil, coriander oil, cypress oil, 1,1-dimethoxy-2-phenylethane, 2,4-dimethyl-4-phenyltetrahydrofuran, dimethyltetrahydrobenzaldehyde, 2,6-dimethyl-7-octen-2-ol, 1,2-diethoxy-3,7-dimethyl-2,6-octadiene, phenylacetaldehyde, rose oxide, ethyl 2-methylpentanoate, 1-(2,6,6-trimethyl-1,3-cyclohexadien-1-yl)-2-buten-1-one, ethyl vanillin, 2,6-dimethyl-2-octenol, 3,7-dimethyl-2-octenol, tert-butylcyclohexyl acetate, anisyl acetate, allyl cyclohexyloxyacetate, ethyllinalool, eugenol, coumarin, ethyl acetoacetate, 4-phenyl-2,4,6-trimethyl-1,3-dioxane, 4-methylene-3,5,6,6-tetramethyl-2-heptanone, ethyl tetrahydrosafranate, geranyl nitrile, cis-3-hexen-1-ol, cis-3-hexenyl acetate, cis-3-hexenyl methyl carbonate, 2,6-dimethyl-5-hepten-1-al, 4-(tricyclo[5.2.1.0]decylidene)-8-butanal, 5-(2,2,3-trimethyl-3-cyclopentenyl)-3-methylpentan-2-ol, p-tert-butyl-alpha-methylhydrocinnam-aldehyde, ethyl [5.2.1.0]tricyclodecanecarboxylate, geraniol, citronellol, citral, linalool, linalylacetate, ionones, phenylethanol and mixtures thereof.

In the context of the present invention, a volatile odorant preferably has a boiling point or boiling point range below 300° C. More preferably, the odorant is a readily volatile compound or mixture. Particularly preferably, the odorant has a boiling point or boiling range below 250° C., more preferably below 230° C., particularly preferably below 200° C.

Preference is likewise given to odorants which have a high volatility. The vapor pressure can be used as a measure of the volatility. In the context of the present invention, a volatile odorant preferably has a vapor pressure greater than 0.001 kPa (20° C.). More preferably, the odorant is a readily volatile compound or mixture. Particularly preferably, the odorant has a vapor pressure greater than 0.01 kPa (20° C.), more preferably a vapor pressure greater than 0.05 kPa (20° C.). Particularly preferably, the odorants have a vapor pressure greater than 0.1 kPa (20° C.).

In addition, it has proved advantageous that the inventive porous metal-organic framework materials can be used for producing a corresponding metal oxide. In this case zirconium dioxide, and also mixed oxides having zirconium and other metals are possible.

### EXAMPLES

### Example 1

5 g of ZrOCl₂ and 9.33 g of terephthalic acid are stirred in 300 ml of DMF in a glass flask for 17 h at 130° C. under reflux. The precipitate is filtered off, washed with 3×50 ml of DMF and 4×50 ml of methanol and predried for 4 days in the vacuum drying cabinet at 150° C. Finally the product is calcined for 2 days in a muffle furnace at 275° C. (100 l/h of air). 5.179 of a brown material are obtained.

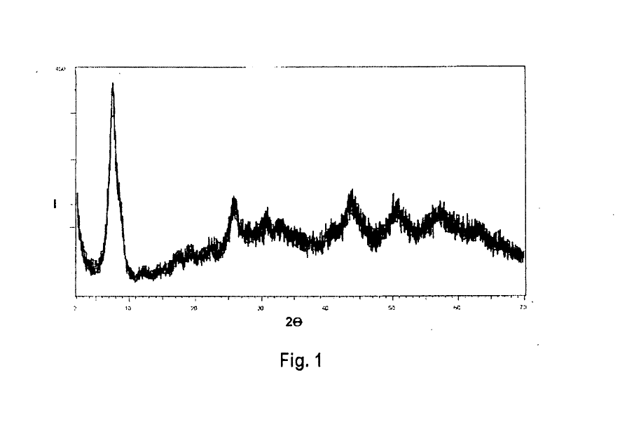

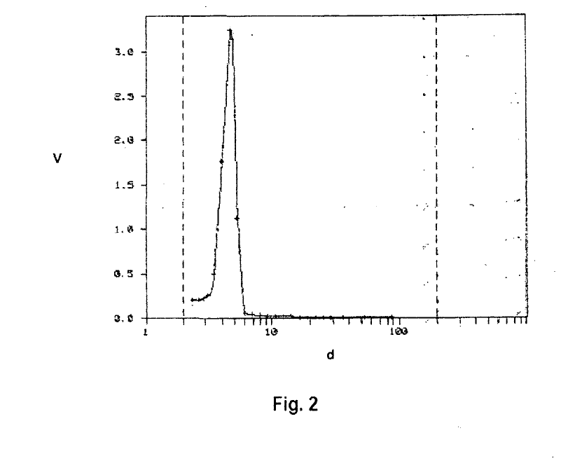

The material, according to elemental analysis, has 26.4% by weight of Zr, 32.8% by weight of C, 37.5% by weight of O, 2.7% by weight of H and traces of Cl and also N. This composition indicates the formation of a Zr-organic compound. FIG. 1 shows the associated X-ray diffractogram (XRD), I showing the intensity (Lin(counts)) and 20 describing the 2-theta scale. The pore structure is shown in FIG. 2. In this case the pore volume V (cm³/g) is shown as a function of the pore diameter d (nm). The surface area is determined by N₂ sorption at 836 m²/g (Langmuir model). The pore volume is 0.5 ml/g. Not only the XRD but also the pore structure, indicate the actual formation of a porous MOF structure.

### Example 2

5 g of ZrO(NO₃)₂.H₂O and 6.67 g of terephthalic acid are stirred in 300 ml of DMF in a glass flask for 17 h at 130° C. under reflux. The precipitate is filtered off, washed with 3×50 ml of DMF and 4×50 ml of methanol and predried for 4 days in the vacuum drying cabinet at 150° C. Finally the product is calcined for 2 days in a muffle furnace at 275° C. (100 l/h of air). 4.73 g of a brown material are obtained.

The material, according to elemental analysis, has 26.0% by weight of Zr, 34.1% by weight of C, 36.7% by weight of O, 2.6% by weight of H, and also small amounts of N (traces of solvent). The surface area is determined by N₂ sorption at 546 m²/g (Langmuir model).

### Example 3

5 g of Zr acetylacetonate and 4.77 g of terephthalic acid are stirred in 300 ml of DMF in a glass flask for 18 h at 130° C. under reflux. The precipitate is filtered off, washed with 3×50 ml of DMF and 4×50 ml of methanol and predried for 20 h in the vacuum drying cabinet at 110° C. Of a total of 4.75 g, 3.91 g are further calcined for 2 days in a muffle furnace at 200° C. (200 l/h of air). 3.43 g of a light-brown material are obtained.

### Example 4

Hydrogen Uptake of the Framework Material from Example 1

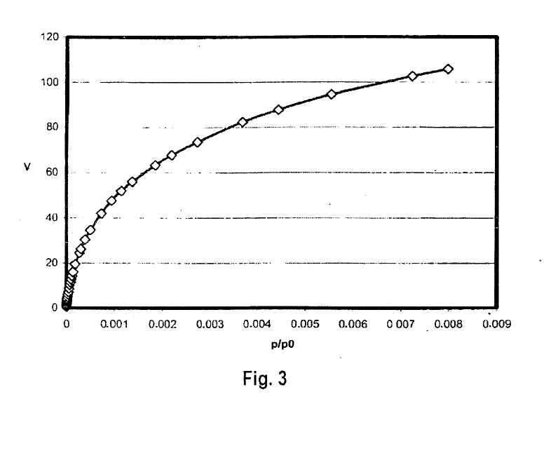

Measurements are performed using a commercially available instrument from Quantachrome having the name Autosorb-1. The measurement temperature was 77.4 K. The samples, before measurement, were in each case pretreated for 4 h at room temperature and subsequently for a further 4 h at 200° C. in vacuum. The resultant curve is shown in FIG. 3. In this case, the H₂ uptake is shown in m²/g MOF (V) as a function of the pressure p/p₀.

### Example 5

Production of Zirconium Oxide

The zirconium-terephthalic acid-MOF from Example 1 is calcined for 48 h at 500° C.

The product is a zirconium oxide having a N₂ surface area of 61 m²/g (Langmuir).

1. A porous metal-organic framework material comprising at least one at least bidentate organic compound which is bound to at least one metal ion by coordination, the at least one metal ion being zirconium, and the at least one at least bidentate organic compound being derived from a dicarboxylic, tricarboxylic or tetracarboxylic acid.

2. The porous metal-organic framework material according to claim 1, wherein the framework is made up only of zirconium metal ions and the at least one at least bidentate organic compound.

3. The porous metal-organic framework material according to claim 1, wherein the at least bidentate organic compound is phthalic acid, isophthalic acid, terephthalic acid, 2,6-naphthanlenedicarboxylic acid, 1,4-naphthalenedicarboxylic acid, 1,5-naphthalenedicarboxylic acid, 1,2,3-benzenetricarboxylic acid, 1,2,4-benzenetricarboxylic acid, 1,3,5-benzenetricarboxylic acid, or 1,2,4,5-benzenetetracarboxylic acid.

4. A method for the production of a porous material-organic framework material according to claim 1, comprising:
reaction of at least one zirconium compound with at least one at least bidentate organic compound which can bind to the metal by coordination.

5. The method according to claim 4, wherein the zirconium compound is an alkoxide, acetonate, halide, sulfide, salt of an organic or inorganic oxygen-comprising acid, or a mixture thereof.

6. The method according to claim 4, wherein the reaction proceeds in the presence of a nonaqueous solvent.

7. The method according to claim 4, wherein the reaction proceeds with stirring.

8. The method according to claim 4, wherein the reaction proceeds at a pressure of at most 2 bar (absolute).

9. The method according to claim 4, wherein the reaction proceeds without additional base.

10. The method according to claim 4, wherein the nonaqueous solvent is a C₁₋₆-alkanol, DMSO, DMF, DEF, acetonitrile, toluene, dioxane, benzene, chlorobenzene, MEK, pyridine, THF, ethyl acetate, optionally halogenated C₁₋₂₀₀-alkane, sulfolane, glycol, NMP, gamma-butyrolactone, alicyclic alcohols, ketones, cycloketones, sulfolene, or a mixture thereof.

11. The method according to claim 4, wherein, after the reaction, the framework material formed is post-treated with an organic solvent and/or if appropriate calcined.

12. (canceled)
